(19) United States
(12) Patent Application Publication
(10) Pub. No.: US 2026/0151697 A1
(43) Pub. Date: Jun. 4, 2026

(54) Thumbstick Adapter

(71) Applicant: David Chapman, Chelmsford, Essex (GB)

(72) Inventor: David Chapman, Chelmsford, Essex (GB)

(21) Appl. No.: 19/129,477

(22) PCT Filed: Nov. 15, 2023
(86) PCT No.: PCT/GB2023/052993

§ 371 Date: May 13, 2025

(30) Foreign Application Priority Data
Nov. 15, 2022 (GB) 2217012.0

(51) Int. Cl. A63F 13/24

(52) U.S. Cl. CPC A63F 13/24

(57) ABSTRACT

A thumbstick adapter comprises a collar that is adapted to engage around a thumbstick and provide a connection for a control at an upper end of the collar, such that a user may engage and manipulate the control, thereby causing movement of the thumbstick. Interchangeable controls may be provided.

### CROSS-REFERENCE TO RELATED APPLICATIONS

This is the U.S. National Stage entry of International Application No. PCT/GB2023/052993, filed Nov. 15, 2023, which claims priority to GB Application No. 2217012.0, filed Nov. 15, 2022. These prior applications are incorporated herein by reference in their entirety.

### FIELD

This invention relates to thumbsticks, and is concerned particularly with adapters for thumbsticks for game controllers, for use with games consoles, and other uses.

### BACKGROUND

Thumbsticks are well known to the very many people who use them. According to Collins English Dictionary, a thumbstick is a ‘small joystick that can be operated by the thumb’, which is apt.

Thumbsticks are widely used in game controllers, video games, personal computers (PCs), mobile controllers for use with mobile phones and tablets, but also in controllers for various devices for example, remotely controlled vehicles, boats and aircraft, including drones. Whilst thumbsticks carry out the functions for which they are designed, they are susceptible to improvement.

Thumbsticks are commonly found as a type of user input device for game controllers designed to facilitate user interaction with a video game or other application executing on a computer, video game console, or other platform. For example, a thumbstick may provide a means by which a user can control a character or object in a video game. The thumbsticks may be manipulated by a user to generate various control signals for interacting with a video game or other application.

Some controllers have more than one thumbstick, with a number of controllers comprising two, one for use by a user's left thumb, and one for use by a user's right thumb. Thumbsticks are thought to improve dexterity and precision when controlling an item within a gaming platform.

Thumbsticks comprise an input device for the controller that is used for two-dimensional input to a gaming platform or computer. This input is based on the position of the thumbstick in relation to the default or centre position. Typically, conventional joysticks rely on a single electrical connection for movement by incorporating internal digital electrical contacts for up, down, left and right. Thumbsticks rely on a continuous electrical activity running through potentiometers to measure the exact position of the thumbstick at any given moment within its full range of motion. This makes thumbsticks highly suitable for video gaming where precision is a key requirement.

Thumbsticks were first used as peripherals for flight simulator games, to allow for micro movements and the subtleties of control required for such titles. But these thumbsticks were found to enhance playability for other titles, such as sports games, battle games, racing games and other platforms where character movement is required.

A thumbstick is often used to move an object within the game, typically a character. The thumbstick can however serve a great variety of other functions, depending on the game. Different games require different precision, movement and dexterity. For some titles, two thumbsticks may offer greater functionality than a single thumbstick. Where two thumbsticks are incorporated within a controller they may be staggered in relation to one another, such that the left stick is positioned to the upper left of a controller while the right stick is positioned to the lower right of the controller. Alternatively, some controllers may have the two thumbsticks in a symmetrical configuration.

With typical gaming titles such as action, adventure games, platforming, and shooting, the left thumbstick normally controls a character's movement while the second thumbstick controls a camera. Typically, the requirements for movement for each thumbstick in this case might be quite different, although the thumbsticks within the controller are often the same on both sides. For other gaming titles, such as car racing and other racing games, battle games, football, and other sports games, the requirements of movement for each of the thumbsticks might again be quite different, even though the actual movement of each of the thumbsticks, and the level of control, are typically the same.

For typical operation, a thumbstick must establish a neutral position. Typically, this would be the thumbstick's very centre when it is not touched or moved. Whenever the thumbstick is moved in any direction, the neutral position could shift to some position away from the centre of the thumbstick, causing the controller to interpret the new position in relation to the neutral position as movement within a game.

A particular user may not have the required dexterity in their thumbs to engage and control a thumbstick to allow them to perform well within a specific game. The requirements for each thumbstick on a console may vary for each game that a user wishes to play, and they may wish to play a number of different games within any gaming session. Current consoles are somewhat limited where the thumbsticks are effectively the same for all games and for all users. Existing thumbsticks do not provide sufficient versatility, variety and customisation to the playability of games consoles.

There is a need to change how a thumb engages with a thumbstick for different users and that is specific for different uses and particularly different genres of game. There is a need to be able to alter the shape and/or size of a thumbstick without any permanent fixings or alterations to a controller. There is a need to allow for ease of changing how a thumb engages with a thumbstick quickly and conveniently.

The prior art shows a number of devices which attempt to address these needs in various ways.

U.S. Pat. No. 7,993,203 (Kontrolfreek LLC) discloses a control mechanism adapter for a game console that allows a user's finger to rest directly on the control mechanism of a game console. The control mechanism adapter connects to the console housing through a plurality of legs. There are legs on the under surface of said base, and attachment elements on the legs to attach the base to a control mechanism of a game console. The base has two raised control elements on the upper surface and on opposing sides of the base. An open centre to the adapter allows a user's thumb to rest on the thumbstick. The user has the option to press against the raised elements, either laterally or with the tip of the thumb. The raised element feature allows the user to manipulate the control lever with less downward muscular force and with improved dexterity. Whilst this adapter helps less dextrous users to control a thumbstick, the interface remains the same for all user's and all gaming platforms. The adapter also affixes to the controller itself, and may in fact restrict some movement of the thumbstick when in use. With repeated application and removal, the thumbstick can become damaged, meaning that the controller may need to be replaced.

US 2021 149 499 discloses an interchangeable input mechanism for control devices, whereby the input devices are configured to receive and removably couple to interchangeable elements. The input mechanism may be a thumbstick, where interchangeable elements can couple to a base component to vary the size, appearance, contour, material or other features of the thumbstick. This device requires disassembly of a controller to insert a new base unit. This device replaces the thumbstick itself, rather than providing an adapter for an existing thumbstick.

CN 107 743 412 discloses a user replaceable thumbstick top for a game controller. The top comprises one or more mating elements that are adapted to mate with corresponding mating elements of a thumbstick base. The user can therefore connect and disconnect the two components without having to take apart the game controller, or without requiring any tools. This device may restrict performance of the thumbstick, rather than enhancing dexterity and improving performance.

WO 2010 018 279 (Dominguez) discloses a precision joystick for a control device, which can be used to increase the precision of a user's movements on the control device. The joystick has been specially configured to be connected to an existing control device and can be used to obtain a greater number of distinct positions on the spherical cap defined by the end of the joystick. This device is solely to enhance precision of movement for an existing joystick, and does not provide customisable, user-specific, game specific solutions.

Whilst the prior art appears to address the issue of improving existing thumbsticks as a means of input to a gaming console or similar, they do not present a device that can adapt a thumbstick for different users, and for different games, to enhance and improve the dexterity and performance for all users. Whilst the prior art aims to provide means to adapt existing thumbsticks, the majority of these require permanent changes to be made to an existing controller, many of which would render any product warranties obsolete and may even cause sufficient damage to the controller to mean it cannot be used.

### BRIEF SUMMARY

Preferred embodiments of the present invention aim to provide an adapter for a thumbstick that releasably secures to the thumbstick without requiring any permanent fixings, the adapter being configured to accept interchangeable, thumb engaging portions. These thumb engaging portions are specific to a user and/or specific to a use, such as for different games, input requirements, precision, functionality. Preferred embodiments also aim to provide thumb engaging portions that can be quickly and conveniently interchanged, prior to a specific user and/or use, or even during a gaming session when a user's requirements may have changed. Preferred embodiments aim to provide thumbsticks that are adapted for individual users and individual user preferences, quickly and easily, during a gaming session.

According to a first aspect of the present invention there is provided a thumbstick adapter comprising a collar that is adapted to engage around a thumbstick and provide a connection for a control at an upper end of the collar, such that a user may engage and manipulate the control, thereby causing movement of the thumbstick.

Preferably, the collar comprises a plurality of interengaging parts that can be engaged around the thumbstick.

Preferably, the collar comprises two interengaging parts that can be engaged around the thumbstick and are provided with one or more releasable clip to secure the interengaging parts together.

Preferably, the two interengaging parts of the collar are connected by a hinge.

The collar may be provided at its lower end with a lip to engage under a surface of a thumbstick.

Preferably, the collar is provided at its upper end with at least one protrusion and/or recess to engage with a corresponding recess and/or protrusion on a control.

Said at least one protrusion and/or recess on the collar and a control may be arranged to snap engage.

Said at least one protrusion and/or recess on the collar and a control may be arranged to twist-lock engage.

The invention extends to a thumbstick adapter according to any of the preceding aspects of the invention, in combination with at least one control.

Said at least one control may be in a configuration selected from an annulus, an accelerator pedal, a dual position control, a width expander, a joystick, a navigation stick, a boot, a bat, a snowboard and a character.

The invention extends to a thumbstick adapter as above, in combination with a plurality of interchangeable controls.

The invention extends to a thumbstick adapter as above, in combination with a control that is formed integrally with, or secured non-detachably to, the collar.

Said control may be in a configuration selected from an annulus, an accelerator pedal, a dual position control, a width expander, a joystick, a navigation stick, a boot, a bat, a snowboard and a character.

In a thumbstick adapter according to any of the preceding aspects of the invention, movement of the thumbstick preferably follows movement of the collar and therefore movement of a control in the collar.

The invention extends to a game or device controller provided with a thumbstick and at least one thumbstick adapter according to any of the preceding aspects of the invention.

### BRIEF DESCRIPTION OF THE DRAWINGS

For a better understanding of the invention and to show how embodiments of the same may be carried into effect, reference will now be made, by way of example, to the accompanying diagrammatic drawings, in which:

FIG. 1 shows one embodiment of thumbstick adapter in isometric view;

FIG. 2 shows the thumbstick adapter of FIG. 1 in exploded viewing, showing a two piece collar interengaging with releasable clip and a hinge about a thumbstick;

FIG. 3 shows the thumbstick adapter of FIGS. 1 and 2 in plan view;

FIG. 4 shows the thumbstick adapter without an interchangeable thumb engaging control;

FIG. 5 shows the thumbstick adapter of FIG. 4 in exploded view, either side of a controller thumbstick;

FIG. 6 shows the thumbstick adapter of FIGS. 4 and 5 in plan view;

FIG. 7 shows, in exploded view, one embodiment of thumbstick adapter engaging with a thumbstick of a controller;

FIG. 8 shows a controller with thumbstick adapter releasably secured to a thumbstick;

FIG. 9 shows the thumbstick adapter in side view, showing one embodiment of releasable clip;

FIG. 10 shows the thumbstick adapter of FIG. 9 in section view, with Section B-B taken along the central axis;

FIG. 11 shows an alternative embodiment of thumbstick adapter, showing a collar comprising two interengaging parts with a releasable clip on each side to releasably secure about a thumbstick;

FIG. 12 shows the thumbstick adapter of FIG. 11 in exploded view;

FIG. 13 shows one embodiment of interchangeable thumb engaging control in the form of an annulus, shown in both front and side views;

FIG. 14 shows a further embodiment of interchangeable thumb engaging control in the form of a foot pedal, shown in plan, front and side views;

FIG. 15 shows a further embodiment of interchangeable thumb engaging control in the form of a dual position control, and shown in plan, side and front views;

FIG. 16 shows yet a further embodiment of interchangeable thumb engaging control in the form of a width expander, in both plan and side views;

FIG. 17 shows a further embodiment of interchangeable thumb engaging control in the form of a mini joystick arrangement in both plan and side views; and

FIG. 18 shows a further embodiment of thumbstick adapter in which a control is formed integrally with a collar.

### DETAILED DESCRIPTION

In the figures like references denote like or corresponding parts.

It is to be understood that the various features that are described in the following and/or illustrated in the drawings are preferred but not essential. Combinations of features described and/or illustrated are not considered to be the only possible combinations. Unless stated to the contrary, individual features may be omitted, varied or combined in different combinations, where practical.

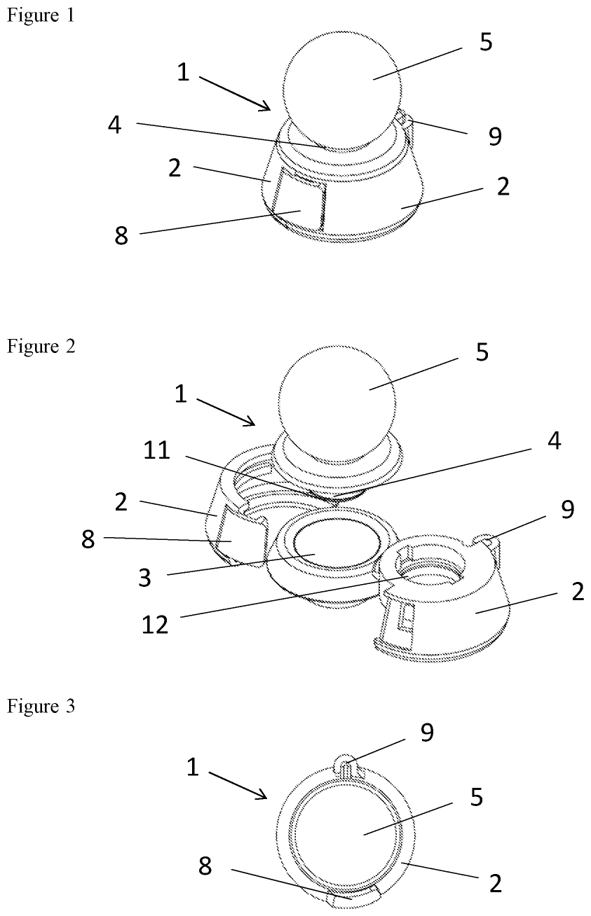

FIG. 1 shows one embodiment of thumbstick adapter 1 for adapting a thumbstick on a controller, not shown. The thumbstick adapter 1 comprises a collar 2 that wraps around an existing thumbstick, and is configured to fit a specific thumbstick of a specific controller. The thumbstick adapter 1 may also be configured to fit a size range of controllers. The collar 2 may comprise two or more parts that are configured to connect together, or may comprise a hinged collar 2, as shown. The collar 2 comprises a hinge 9 and releasable clip 8 opposite the hinge 9, where the collar 2 is opened by the hinge 9 and wrapped about the thumbstick, then secured with the releasable clip 8. The collar 2 may also comprise a one piece component, not shown.

FIG. 1 shows one possible embodiment of a control 5, where the control 5 is interchangeable with the collar 2. The control 5 as shown is ball shaped. The control 5 connects to the collar 2 by a connector 4. FIG. 2 shows the connector 4 comprising a protrusion 11 as part of the control 5, that is arranged to connect to the collar 2 by inserting into a corresponding recess 12. The connector 4 may comprise a push-fit, snap-fit, slot-fit, friction-fit or twist-fit arrangement. Alternatively or additionally, the connector 4 may comprise magnets.

FIG. 2 shows the thumbstick adapter in exploded view about a typical thumbstick 3. The collar 2 is shown in two parts, with hinge 9 disconnected, and releasable clip 8 released. In use, the collar 2 is secured about the thumbstick 3 and the releasable clip 8 is clipped shut. This leaves the recess 12 ready for the protrusion 11 of a chosen control 5 to be inserted and releasably secured. In this embodiment the protrusion 11 is inserted into the recess 12 and pushed to snap-fit and engage. This securely mounts the control 5 to the collar 2, until such time as a user decides to switch controls 5, where the control 5 is pulled in the opposite direction to remove the protrusion 11 from the recess 12.

FIG. 3 shows the thumbstick adapter 1 in plan view, showing the hinge 9 on one side of the collar 2, and the releasable clip 8 on the opposite side of the collar 2.

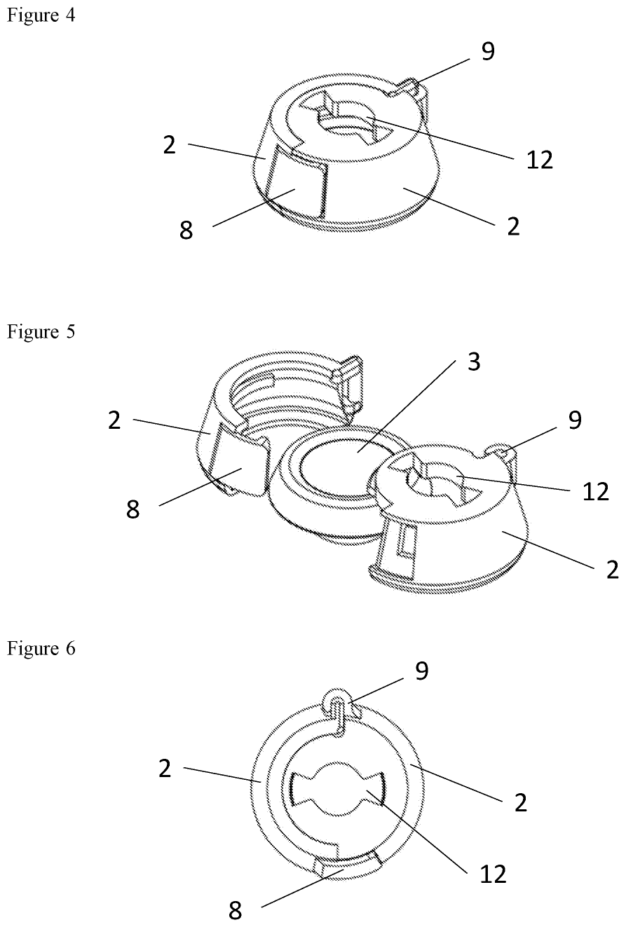

FIG. 4 shows the collar 2 without the control 5, showing one embodiment of recess 12 in keyhole shape. FIG. 5 shows this collar 2 in exploded view, in relation to a typical thumbstick 3, where the collar 2 is wrapped about the thumbstick 3 by the hinge 9 and secured with the releasable clip 8. The releasable clip 8 being capable of being released from the thumbstick 3. FIG. 6 shows this arrangement of collar 2 in plan view, showing the twist-lock recess 12.

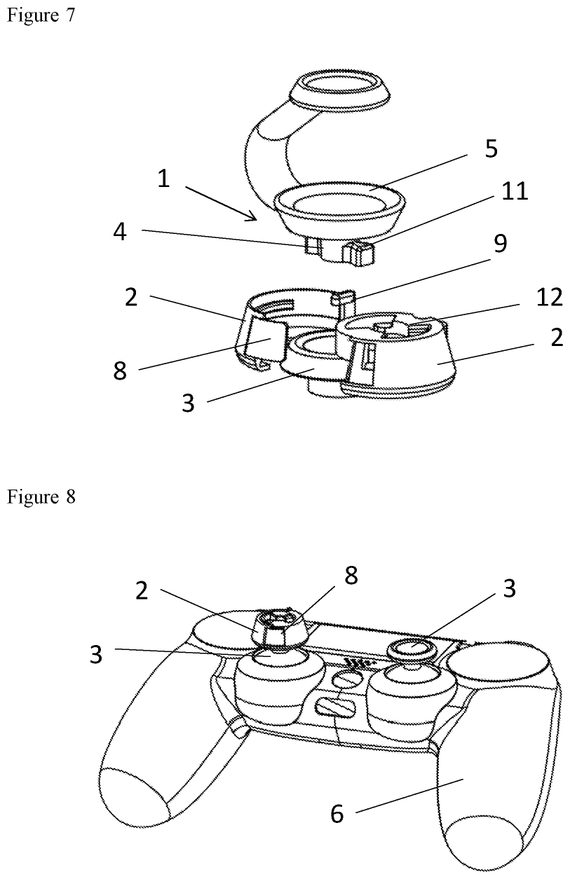

FIG. 7 shows connector 4 between control 5 and collar 2 in greater detail, the shape of the connector 4 being suitable for insertion within the recess 12 through the protrusion 11. The connector 4 of control 5 is inserted into the recess 12 and turned or rotated within the recess 12 through a quarter turn to lock in place. To remove the control 5, the control 5 is turned in the same or opposite direction by a similar quarter turn, and removed from the recess 12. The protrusion 11 is shaped to fit and turn to secure within the recess 12, to provide twist-lock engagement.

In the embodiment shown, the recess 12 is effectively a slot, with the protrusion 11 in the base of the control 5 being configured to pass into the slot, where it is rotated to lock into place. In a further embodiment, the control 5 may be releasably secured to the collar 2 about its peripheral edge. The collar 2 may incorporate a lip, over which a protrusion about an edge of connector 4 may be configured to clip. Connector 4 may comprise a spring loaded clip that is depressed to engage with the collar 2, and pressed again for removal from the collar 2.

In yet a further embodiment, the collar 2 may incorporate two spring loaded push points on opposing sides that can be squeezed to insert control 5 and squeezed again to release the control 5.

FIG. 8 shows one embodiment of a typical games console 6 showing the thumbstick adapter 1 in position on one of two thumbsticks 3.

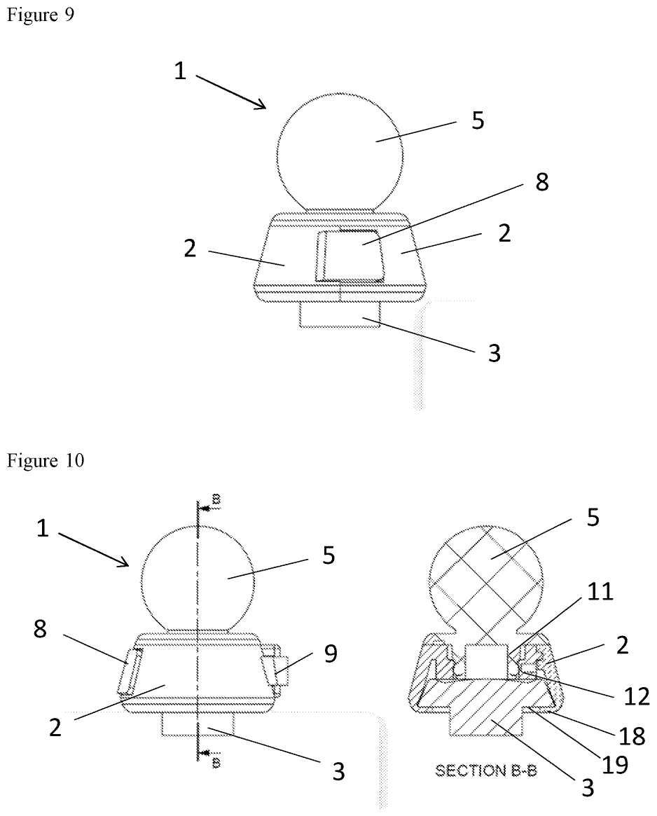

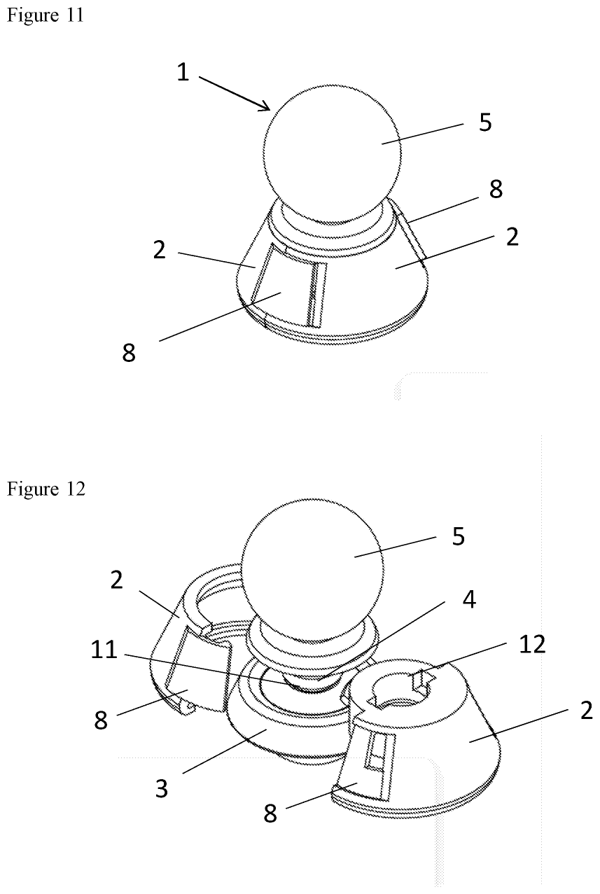

FIG. 9 shows a side view of the thumbstick adapter 1 showing the two part collar 2 engaged about the thumbstick 3, where movement of the control 5 would relay an equivalent movement to the thumbstick 3. FIG. 10 shows this thumbstick adapter 1 with Section B-B showing the interrelationship of control 5 to collar 2 to thumbstick 3. As may be seen in the sectional view of FIG. 10, the collar 2 has a lower peripheral lip 18 that returns inwardly to engage a lower surface 19 of the thumbstick 3, thereby to assist engagement of the collar 2 with the thumbstick 3.

The collar 2 may take various other forms, not shown, such as a silicone or similar resilient material skirt, whereby the skirt is stretched or pushed over the thumbstick 3 to grip the collar 2 in position. The collar 2 may comprise a rigid plastics material, with a construction such as to provide some give so that it is suitable to flex around the thumbstick 3 to secure into position. Where the collar 2 comprises a hinge 9, the collar 2 may be secured with an elastic band arrangement where the elastic band releasably secures one part of the collar 2 to the other part of the collar 2 by looping one end around a projection or peg. The hinged collar 2 may alternatively be releasably secured in place by a silicone strap, not shown.

Hinges such as 9 may be provided by a resilient material rather than a pivot.

In a further embodiment, the collar 2 may comprise a hinge 9 to open and close the collar 2 to wrap around the thumbstick 3, and the releasable clip 8 may comprise a squeeze clip, that opens and closes the collar 2 by pinching it open. Alternatively, the collar 2 may comprise a hinge 9 and the releasable clip 8 may comprise a sliding mechanism to release the collar 2 from the thumbstick 3 or to secure it into position for use. The collar 2 may alternatively comprise two parts, where a lower part incorporates a screw threaded portion, and an upper part incorporates a corresponding screw threaded portion, such that the threaded portions engage and lock or unlock to release the upper part. The upper part may incorporate means to support the controls 5.

In yet a further embodiment, the collar 2 may incorporate a silicone lining or insert to provide some give or resilience for engaging with multiple thumbstick 3 sizes. This silicone lining or insert may be incorporated with any of the collar 2 configurations proposed.

The collar 2 may comprise a hard plastic lip that engages with a number of different thumbstick 3 sizes. This hard plastic lip may be incorporated with any of the collar 2 configurations proposed.

Where the collar 2 incorporates a plurality of flexible portions about the periphery, the control 5 may be configured to click onto these flexible portions. The collar 2 may comprise multiple projections or teeth, that releasably secure to a thumbstick 3 by a push to engage with the thumbstick 3, or through a threaded sleeve, rotated to engage the thumbstick 3.

In yet a further embodiment, the releasable clip 8 may comprise a quick release clip mechanism, such as those used for bicycle seats and/or wheels, where a gap or in the collar 2 is opened or closed through an inbuilt spring clip or screw. A ratchet element may also be incorporated into the collar 2 to pinch the collar 2 into a closed position about the thumbstick 3.

FIG. 11 shows a further embodiment of thumbstick adapter 1 with collar 2 where the collar 2 comprises two parts, and two releasable clips 8 to join the two parts together about the thumbstick 3, prior to insertion of the control 5 into the recess 12. FIG. 12 shows this same thumbstick adapter 1 where the collar 2 comprises two parts, and in exploded view to show how these engage with each other about the thumbstick 3.

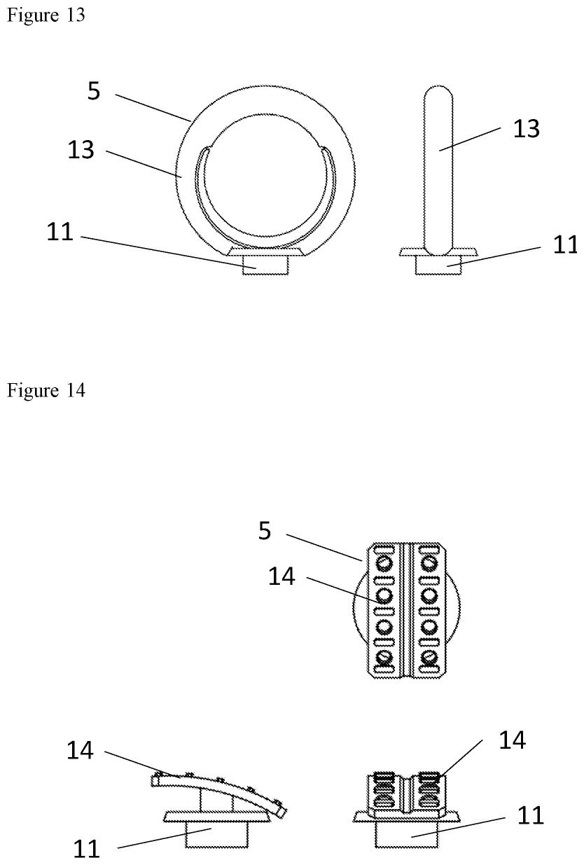

FIGS. 13, 14, 15 and 16 cover some of the possible controls 5 that can be interchanged with the collar 2 according to a user's preferences or requirements. FIG. 13 shows an annulus 13 provided with the protrusion 11 for engaging with the recess 12 created by the collar 2. A user places their thumb within the annulus 13 to assist with control when moving laterally.

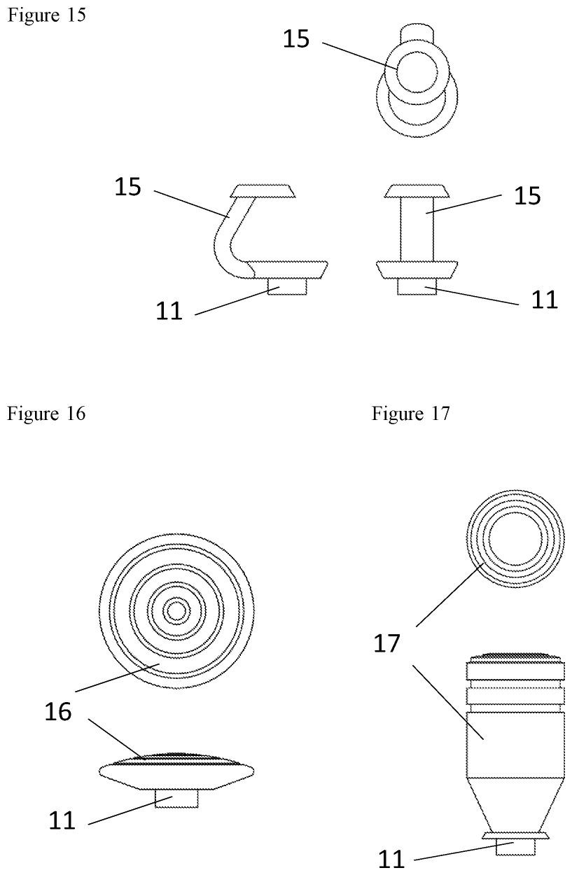

FIG. 14 shows the control 5 when configured as an accelerator pedal 14, designed for use with driving games, shown in plan, side and front views. The accelerator pedal 14 is provided with grips to simulate a real accelerator pedal, whilst also providing grip and dexterity when moving the thumb along the pedal to accelerate.

FIG. 15 shows the control 5 when configured as a dual position control 15, whereby the protrusion 11 is inserted into the recess 12 within the collar 2, and the dual position control 15 offers the user two different heights of thumb control 5 for different agility and precision. The lower position might offer improved speed when engaging with a specific gaming platform, with the upper position providing better precision. The dual position control 15 allows the user to switch between the two positions instantaneously.

FIG. 16 shows the control 5 when configured as a width expander 16, which is similar in shape to many existing thumbsticks that comprise a mushroom shape, but expands the width of this shape for additional dexterity. FIG. 17 converts the thumbstick adapter 1 into a mini joystick 17.

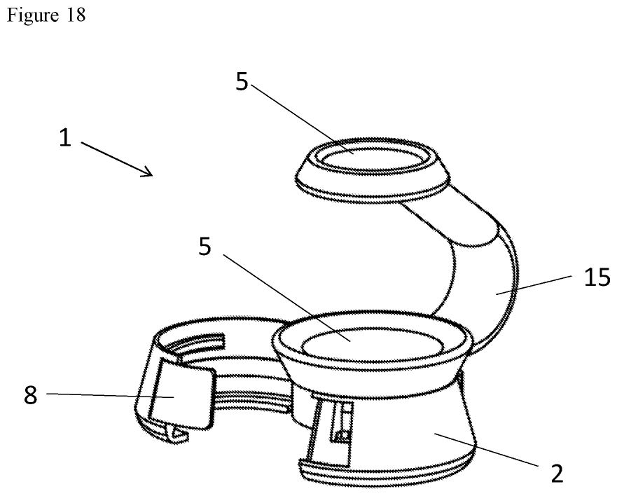

FIG. 18 shows an adapter 1 configured as a dual position control 15, offering the user two different heights of thumb control 5 for different agility and precision—similar to the adapters shown in FIGS. 7 and 15. However, in FIG. 18, the control 15 is formed integrally with, or secured non-detachably to, the collar 2 that, in use, engages around a thumbstick. Such a construction may also be employed with controls 5 of other configurations, such as those illustrated and described above. In this example, the collar 2 has two hinged parts that are secured together by a clip 8 or other fastener, when engaged around a thumbstick.

Whilst collar 2 is illustrated and described above as comprising two parts that are secured together, it could comprise more than two parts that are secured together by one or more hinge, clip or other fastener.

Some thumbsticks comprise a removable outer part that engages detachably with a spigot that is provided on a respective controller. One such outer part may be detached from the spigot and replaced with an alternative outer part, thereby affording a thumbstick of an alternative configuration. In the context of this specification, the term ‘thumbstick’ means either a complete thumbstick or a spigot for a thumbstick outer part. That is, a thumbstick adapter embodying the invention may engage the spigot directly.

In this specification, terms of absolute orientation are used for convenience to denote a typical orientation of a thumbstick in use and/or as shown in the accompanying drawings. However, thumbsticks could be disposed in other orientations, and in the context of this specification, terms of absolute orientation, such as “top”, “bottom”, “left”, “right”, “vertical” or “horizontal”, etc. are to be construed accordingly, to include such alternative orientations.

In this specification, the verb “comprise” has its normal dictionary meaning, to denote non-exclusive inclusion. That is, use of the word “comprise” (or any of its derivatives) to include one feature or more, does not exclude the possibility of also including further features. The word “preferable” (or any of its derivatives) indicates one feature or more that is preferred but not essential.

All or any of the features disclosed in this specification (including any accompanying claims, abstract and drawings), and/or all or any of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent, or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1-16. (canceled)

17. A thumbstick adapter comprising a collar that is adapted to engage around a thumbstick and provide a connection for a control at an upper end of the collar, such that a user may engage and manipulate the control, thereby causing movement of the thumbstick, wherein the collar comprises two interengaging parts connected by a hinge, that can be engaged around the thumbstick and are provided with one or more releasable clip to secure the interengaging parts together.

18. The thumbstick adapter of claim 17, wherein the collar comprises more than two interengaging parts that can be engaged around the thumbstick.

19. The thumbstick adapter of claim 17, wherein the collar is provided at its lower end with a lip to engage under a surface of a thumbstick.

20. The thumbstick adapter of claim 17, wherein the collar is provided at its upper end with at least one protrusion and/or recess to engage with a corresponding recess and/or protrusion on a control.

21. The thumbstick adapter of claim 20, wherein said at least one protrusion and/or recess on the collar and a control are arranged to snap engage.

22. The thumbstick adapter of claim 20, wherein said at least one protrusion and/or recess on the collar and a control are arranged to twist-lock engage.

23. The thumbstick adapter of claim 17, in combination with at least one control.

24. The thumbstick adapter of claim 23, wherein said at least one control is in a configuration selected from an annulus, an accelerator pedal, a dual position control, a width expander, a joystick, a navigation stick, a boot, a bat, a snowboard, and a character.

25. The thumbstick adapter of claim 23, in combination with a plurality of interchangeable controls.

26. The thumbstick adapter of claim 17, in combination with a control that is formed integrally with, or secured non-detachably to, the collar.

27. The thumbstick adapter of claim 26, wherein said control is in a configuration selected from an annulus, an accelerator pedal, a dual position control, a width expander, a joystick, a navigation stick, a boot, a bat, a snowboard and a character.

28. The thumbstick adapter of claim 17, wherein movement of the thumbstick follows movement of the collar and therefore movement of a control in the collar.

29. A game or device controller comprising a thumbstick and at least one thumbstick adapter comprising a collar that is adapted to engage around a thumbstick and provide a connection for a control at an upper end of the collar, such that a user may engage and manipulate the control, thereby causing movement of the thumbstick, wherein the collar comprises two interengaging parts connected by a hinge, that can be engaged around the thumbstick and are provided with one or more releasable clip to secure the interengaging parts together.
